(19) United States
(12) Patent Application Publication
(10) Pub. No.: US 2016/0055776 A1
(43) Pub. Date: Feb. 25, 2016

(54) ELECTRONIC SIGNAGE FOR TOWER APPLICATIONS

(71) Applicants: Anthony Richard Lanzito, Elmwood Park, IL (US); Jonathan Splitt, Riverside, IL (US)

(72) Inventors: Anthony Richard Lanzito, Elmwood Park, IL (US); Jonathan Splitt, Riverside, IL (US)

(73) Assignee: Tower Media LLC, River Grove, IL (US)

(21) Appl. No.: 14/810,068

(22) Filed: Jul. 27, 2015

Related U.S. Application Data
(60) Provisional application No. 62/029,241, filed on Jul. 25, 2014.

(51) Int. Cl. G09F 23/00; G09F 7/18

(52) U.S. Cl. CPC G09F 23/00; G09F 7/18; G09F 2007/1843; G09F 2007/1847; G09F 2007/1856; G09F 2007/1873

(57) ABSTRACT

Signage structure for attachment an advertising or other display to an existing water tower or other vertical architectural structure. The signage has a support frame including mounting elements attachable to vertical tower supports of the water tower. The mounting elements include an upper mounting element having a first length and a lower mounting element having a second length that is less than the first length. The electronic display is supported on the support frame in a portrait configuration, and the electronic display is disposed at an angle to vertical upon attachment to the architectural structure due to the first length of the upper mounting element and the second length of the lower connection.

### CROSS REFERENCE TO RELATED APPLICATION

This application claims the benefit of U.S. Provisional Patent Application, Ser. No. 62/029,241, filed on 25 Jul. 2014. The co-pending Provisional Application is hereby incorporated by reference herein in its entirety and is made a part hereof, including but not limited to those portions which specifically appear hereinafter.

### BACKGROUND OF THE INVENTION

This invention relates generally to billboard advertising and, more particularly, to an advertising display structure for attachment to tower structures, such as water towers, silos, antennae, etc.

The advertising world has always sought to place signage in conspicuous well-traveled places. The traditional painted or decaled billboard signs constructed to line highways have traditionally been high visibility sources for single product advertising. These signs, though visible, have typically been single source advertisements which required repainting or new decal installation to change products or message. With the advent of electronic signs and digital displays, the possibility to have multiple products advertised in a single location has greatly increased. These displays are currently used in billboard applications and create a significant increase in revenue to the sign owners. Through use of a digital or electronic billboard, a multitude of products may be advertised and revenues collected for each.

Water towers, silos and storage towers are located in towns throughout the country and typically display a hometown name and/or team name, visible to everyone. There is a need to improve the use of such structures for revenue generation.

### SUMMARY OF THE INVENTION

The invention incorporates an electronic sign or digital display attached to a tower. This invention allows the city, town or village to continue self-identification on the towers and adds the potential of revenue by having the electronic display signs located on the tower.

The general object of the invention can be attained, at least in part, through signage for attachment to an architectural structure having a vertical orientation, such as a water or storage tower, including a display attached to the architectural structure by a support frame at an angle to the vertical orientation. The invention further includes signage for attachment to an architectural structure having a vertical orientation, where the signage structure includes a support frame including an upper mounting element having a first length and a lower mounting element having a second length that is less than the first length, and a display supported on the support frame. The display, which desirably is an electronic display in a portrait configuration, is desirably disposed at an angle to vertical upon attachment to the architectural structure as a function of the first length of the upper mounting element and the second length of the lower connection.

The invention further includes a method of connecting signage to an existing water tower or similar structure. The method includes attaching a support frame to and between two vertical tower supports, attaching a display to the support frame, and angling the display with respect to vertical and/or the vertical tower supports. The display then shows thereon any programmed messages, such as billboard advertising, etc.

The portrait-oriented display can include any of various electronic display devices capable of sequencing a series of video or still images on a display surface. In its attached portrait-oriented position, the electronic display will have a greater height than width.

The components of the sign mounting assembly preferably include a sign mounting support frame, and upper and lower mounting clamps. The support frame is preferably attached to the tower support legs by the upper and lower mounting clamps. The clamps are designed such that the electronic display is situated in a portrait orientation where the display surface is desirably at an angle relative to vertical and more preferably less than perpendicular to vertical, thereby providing better viewing below. The electronic display is fixedly attached to the support frame. The support frame is preferably formed of lateral and vertical frame support members. The lateral and vertical support members keep the electronic display in place.

The position of the electronic display relative to the storage tower is such that the storage tower with any existing identifying information is desirably not covered by the electronic display. The overall design and footing foundation revisions include consideration for the wind force effects and additional load on the storage tower. With proper calculation, a number of electronic displays can be installed on a single multi-legged tower.

As used herein, references to “vertical” are to be understood to refer to generally perpendicular to the horizontal, namely the surface of the earth. Further, references herein to “portrait” or “portrait orientation” are to be understood to refer to a longer dimension being parallel to the vertical, and a shorter dimension being parallel to the horizontal.

Other objects and advantages will be apparent to those skilled in the art from the following detailed description taken in conjunction with the appended claims and drawings.

### BRIEF DESCRIPTION OF THE DRAWINGS

FIGS. 1 and 2 show signage according to one embodiment of this invention, attached to a multi-leg or column water tower.

FIG. 3 shows a support frame attachment to a display video screen, according to one embodiment of this invention.

FIGS. 4 and 5 representatively show a top view of a support frame and mounting elements according to one embodiment of this invention.

FIGS. 6 and 7 show an upper mounting element according to one embodiment of this invention.

FIGS. 8 and 9 show a lower mounting element according to one embodiment of this invention.

FIGS. 10 and 11 show signage according to another embodiment of this invention.

FIG. 12 shows signage of this invention attached to a differently sized water tower.

FIG. 13 illustrates a reinforcement footing according to one embodiment of this invention.

FIGS. 14 and 15 show signage according to another embodiment of this invention, attached to a standpipe water tower.

FIGS. 16 and. 17 show a center mounting element, according to one embodiment of this invention.

FIG. 18 illustrates a mounting element of FIGS. 14 and 15, according to one embodiment of this invention.

FIG. 19 illustrates a brace for the support column of FIGS. 14-17, according to one embodiment of this invention.

### DETAILED DESCRIPTION OF THE INVENTION

The present invention provides advertising display structure for attachment to existing, vertically tall architectural structures, such as tower structures, including, without limitation, water or storage towers, silos, antennae, etc. The invention is particularly useful for providing billboard advertising in empty or underused space on the side of these types of vertical structures, thereby providing additional revenue sources for municipalities or other owners. The display can also be used for messages, such as announcements for events (e.g., a county fair), due dates or other requirements (e.g., tax due dates), and/or emergencies (e.g., AMBER alerts or storm warnings).

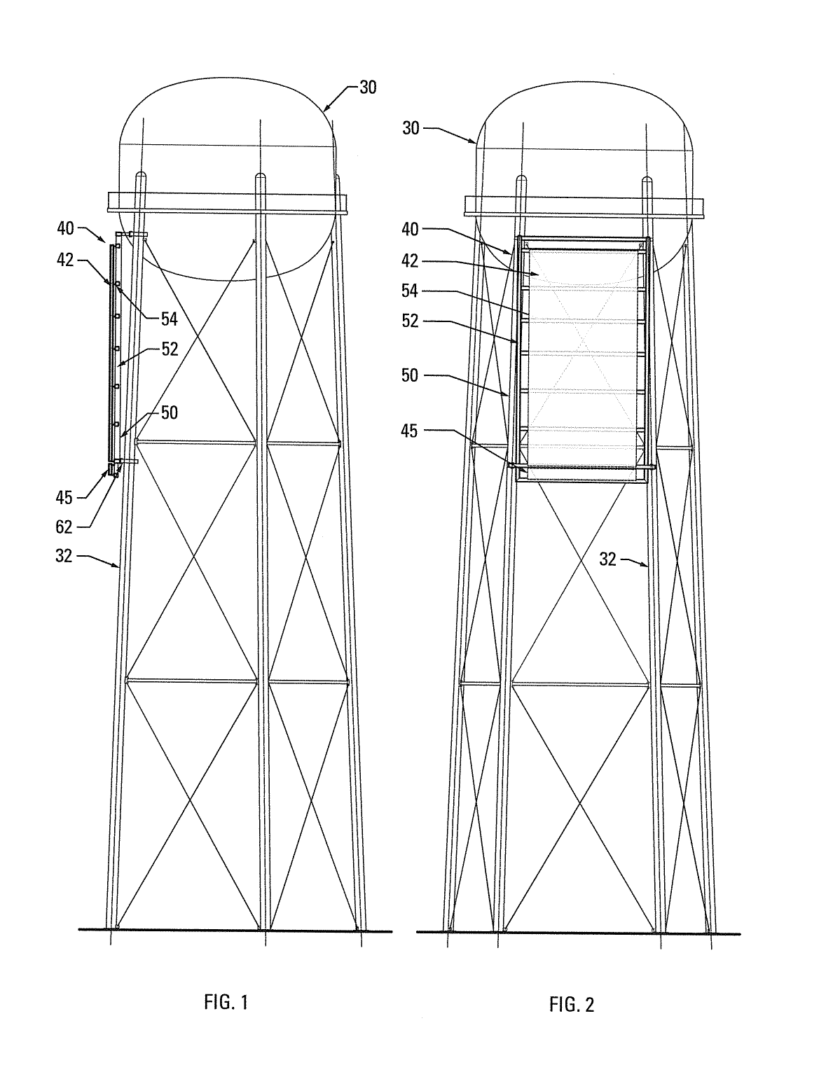

FIG. 1 shows signage 40 according to one embodiment of this invention attached to a multi-leg or column water tower 30. The signage 40 includes a display 42, such as for including an advertisement or other message. The display 42 can be any suitable display, such as a print display, but is preferably an electronic display. Any suitable electronic display can be incorporated in this invention, such as a video screen. The display further includes any suitable data processor and/or storage medium equipment, as is known in the art, for storing and displaying messages on, and otherwise controlling, the electronic display. Electric power can be provided according to local municipal codes, such as by added or existing wiring on the tower 30. Desirably, the electronic display is controllable from a remote locate, such as for uploading and/or changing display content, by a wired or wireless connection. Those skilled in the art will appreciate that various and alternative weatherproof displays and supporting equipment can be used in this invention, depending on need.

In preferred embodiments of this invention, the display 42 is a portrait display having the longer dimension of the rectangular display 42 in a vertical orientation. As shown in FIG. 2, a portrait orientation of the display 42 provides a larger display size, while fitting on and between two vertical tower supports 32 of the water tower. By having the opposing edges of the display 42 and/or support frame 50 aligned with, or approximate two corresponding vertical tower supports 32, the signage provides a preferred aesthetic while improving strength (e.g., improved wind resistance). In embodiments of this invention, the display 42 is at an angle relative to vertical, and more preferably less than perpendicular to the horizontal surface below. The angling downward of the display improves viewing from below. Two or more displays can optionally be included on the support frame, such as a smaller, non-electronic, and/or fixed message display 45 shown in FIG. 1, such as the name of the town or other town-related announcements posted below the larger display. Furthermore, two or more displays 42 can be attached, each to a different side of the water tower 30, depending on need.

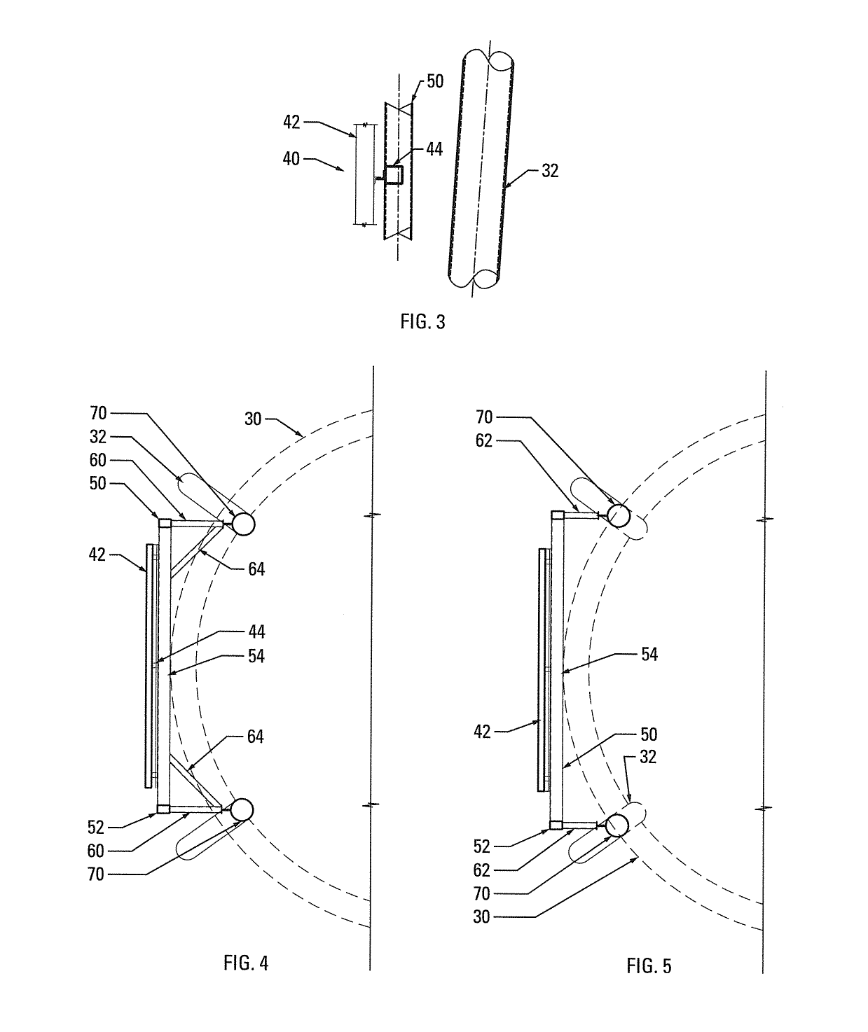

The support frame 50 is attached to the display 42 and secures the display 42 to the water tower 30. The display 42 can be attached to the support frame 50 by any suitable connection mechanism, such as by various and alternative fasteners as known in the art, for example, without limitation, the interconnecting brackets 44 shown in FIG. 3 and/or bolts. The display 42 is desirably removable connected to the support frame 50 to allow for a replacement display upon need. As shown in FIG. 2, the support frame 50 includes two vertical supports 52 on opposing sides of the support frame 50, and a plurality of spaced apart lateral supports 54 extending between the vertical supports 52. Various and alternative sizes, shapes, numbers, and/or configurations are available for the support frame and vertical/lateral supports, depending on need and the size and type of the display. Desirably the support frame can be sized approximate to the display, to reduce or eliminate the amount of support frame seen from the ground.

As shown in FIG. 1, the support frame 50 includes mounting elements for connecting the support frame 50 between two vertical tower supports 32 of the water tower 30. Each of a pair of upper mounting elements 60 is attached between an upper corner of the support frame 50 and a corresponding one of the vertical tower supports 32. Each of a pair of lower mounting elements 62 is attached between a lower corner of the support frame 50 and a corresponding one of the vertical tower supports 32. In embodiments of this invention, the upper mounting elements 60 have a length that is longer than the shorter lower mounting elements 62. The size difference between the upper and lower mounting elements 60 and 62 can be used to place the display in a vertical orientation, such as when the vertical tower supports 32 angle inward as shown in FIG. 1. More desirably, the longer upper mounting elements 60 can be sized to angle the top of the display downward, e.g., with the top angled from vertical, as discussed above to allow better viewing from below.

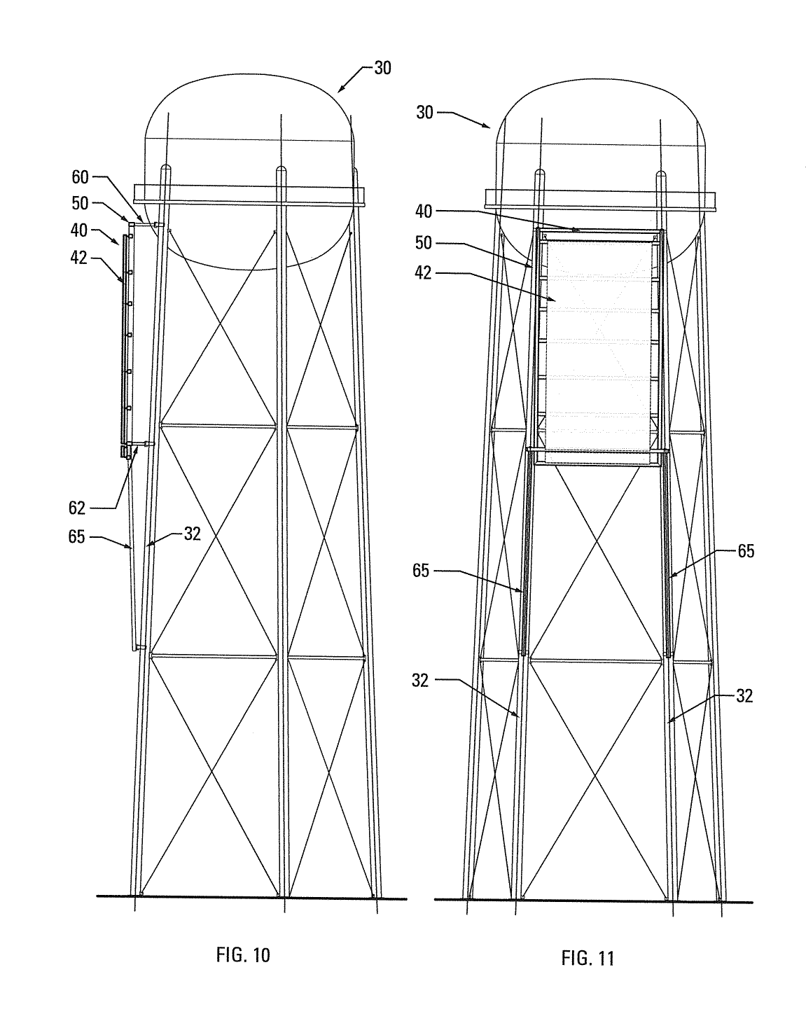

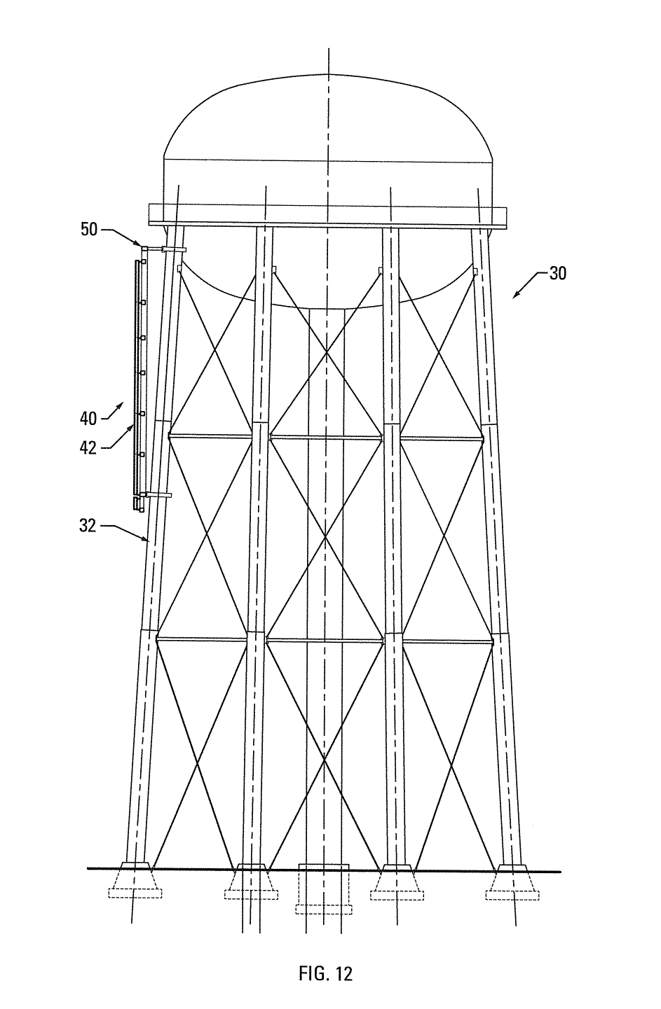

As will be appreciated, various and alternative sizes, amounts, and configurations of the mounting elements will vary depending on need, such as the size and configuration of the support frame and water tower, and/or the desired angling of the top and/or bottom of the signage. For example, FIGS. 10 and 11 illustrate an optional lower support beam 65 extending from the bottom end of the support frame 50 to a lower position on the water tower 30. Whereas the upper and lower mounting elements 60 and 62 extend generally perpendicular from a side of the support frame 50 opposite the display 42, the lower support beam 65 extends out from the end of the support frame 50 closer to parallel with the support frame 50, and is angled toward the water tower 30 as needed to contact the intended attachment point. FIG. 12 shows the display 42 and support frame 50 of this invention attached to a differently sized water tower 30, having a different number and spacing of vertical tower supports 32.

FIGS. 4 and 5 representatively show a top view of the support frame 50 and mounting elements 60 and 62, respectively. As shown in FIG. 4, the upper mounting element 60 includes an optional angled support 64 for further structural support. The mounting elements 60 and 62 each include a connector 70 to attach to the vertical tower support 32. The connector is desirably a clamp 70 that extends at least partly around the corresponding support 32. As shown in FIGS. 4-9, the clamp 70 can include a rounded section to match the support 32, and be welded to the tower support 32. Various and alternative connectors and/or clamps can be used, such as friction clamps.

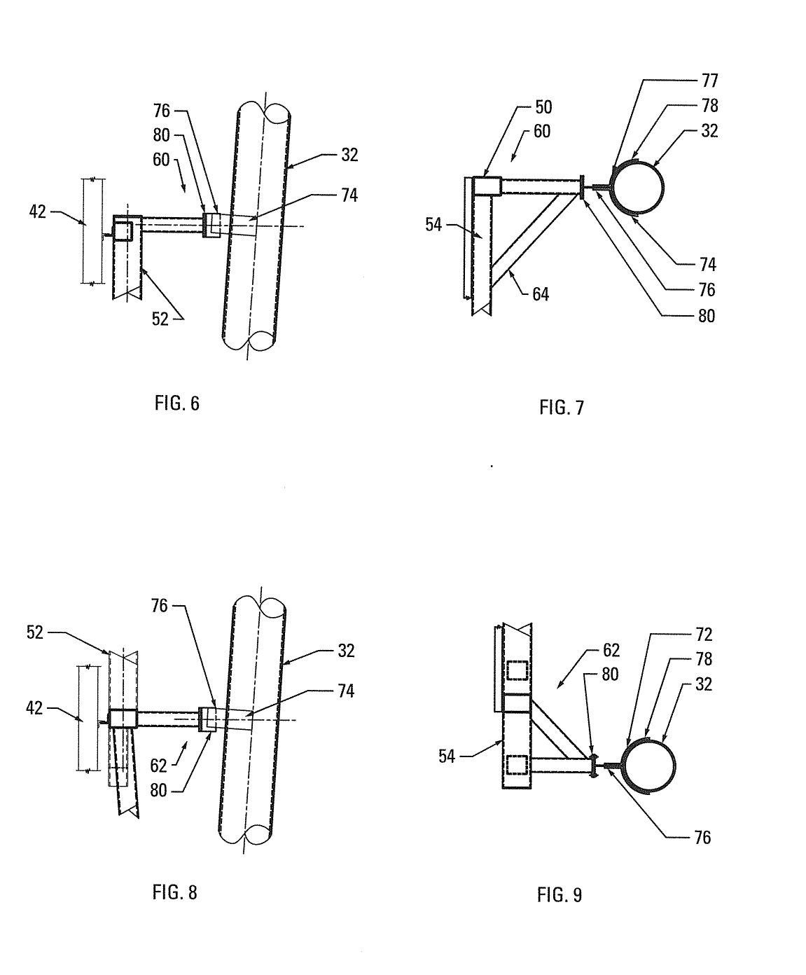

FIGS. 6 and 7 show an upper mounting element 60 according to one embodiment of this invention. FIGS. 8 and 9 show a lower mounting element 62 according to one embodiment of this invention. Each mounting element 60 and 62 includes a clamp 70, embodied as a first clamp piece 72 and a second clamp piece 74, each having an arm 76 extending outward from a rounded section 78 that is welded to the support 32. A bent plate 80 includes a portion welded or bolted between the two arms 76. The bent plate 80 provides an angled portion of the mounting element 60 or 62 to tilt the support frame 50 and the display 42 relative to the tower support legs 32 and/or the vertical axis of the water tower.

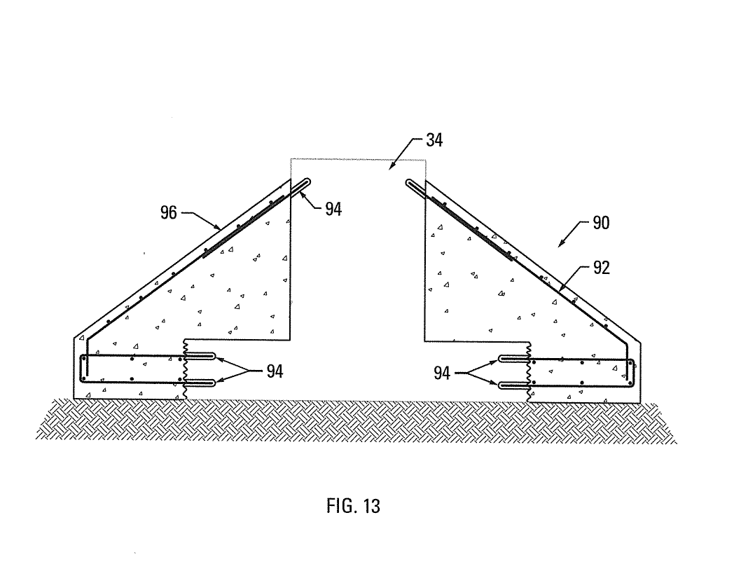

In view of the additional weight added to the water tower, additional support may be needed for the water tower. FIG. 13 illustrates a reinforcement footing 90 according to one embodiment of this invention, for reinforcing the vertical tower supports 32 of the water tower. The reinforcement footing 90 is added around the existing footing 34 of each water tower vertical tower support 32. A footing frame 92 is attached to the existing footing 34, such as by applying inserts 94 into the concrete of the existing footing 34, according to known techniques. A concrete footing extension 96 is poured around the footing frame to form a new, expanded footing for the vertical tower support. Various and alternative sizes, shapes, materials, and configurations are available for the reinforcement footing, the footing frame, and the footing extension, depending on application need.

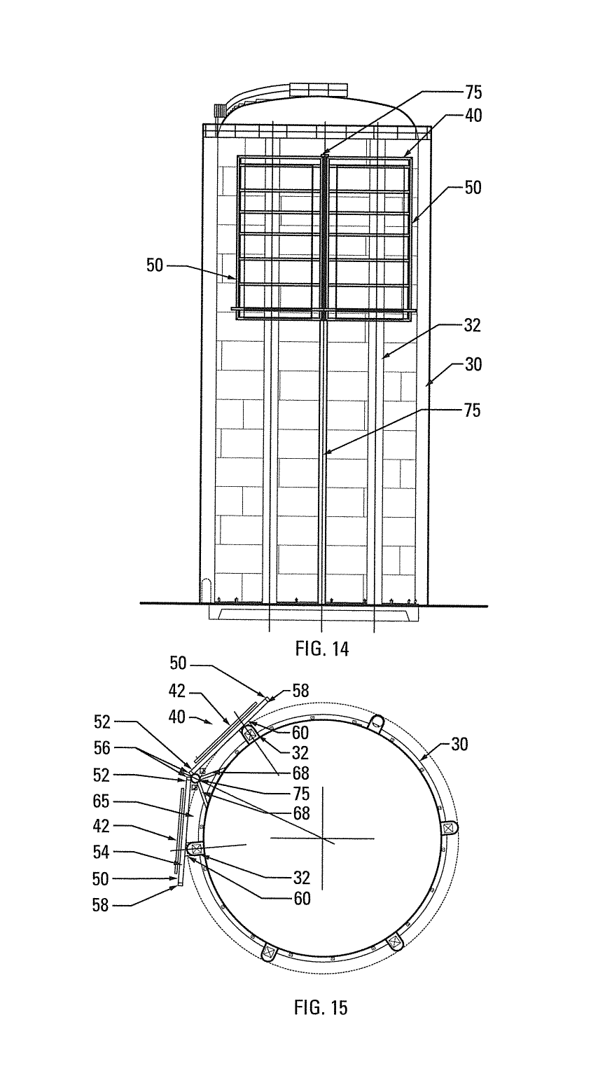

FIGS. 14 and 15 show signage 40 according to another embodiment of this invention, attached to a standpipe water tower 30. In FIGS. 14 and 15 two support frames 50 are positioned next to each other at adjacent inner sides 56, and at an angle such that each frame 50 connects to a vertical tower support 32 (e.g., a pilaster) of the water tower 30 near an outer side edge 58. Each support frame panel 50 includes an upper mounting element 60 and a lower mounting element (not shown) that each connects to a vertical tower support 32. Each support frame 50 is connected at or near the vertical support 52 of an inner side 56 of the support frame 50, to at least one center mounting element 65, and desirable two (e.g., an upper and lower) center mounting element 65.

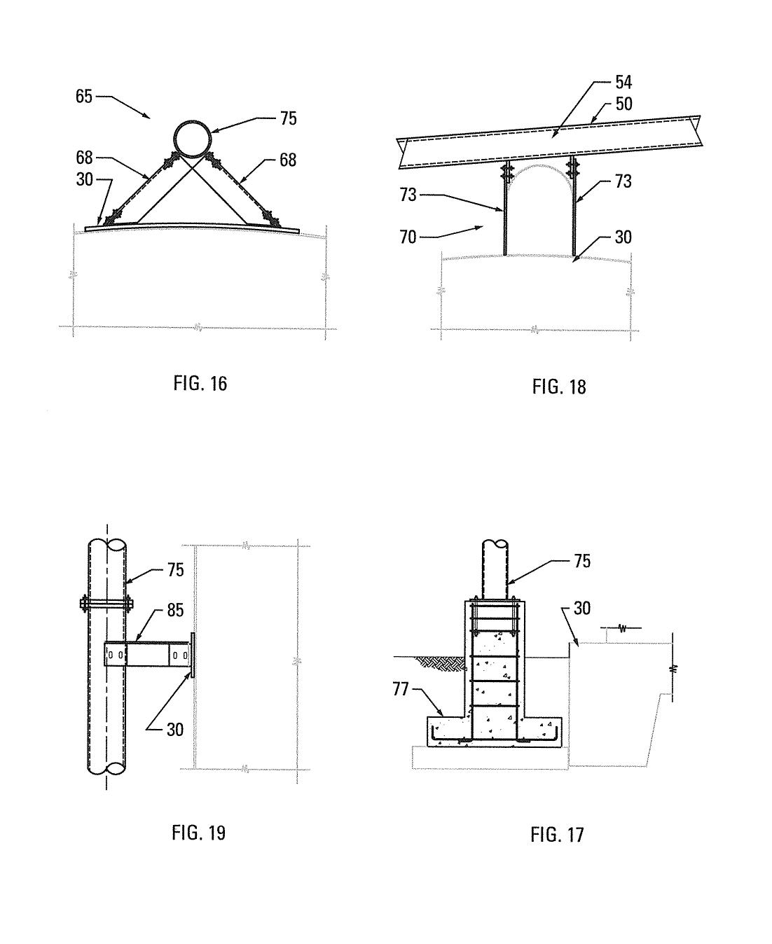

As shown in FIGS. 15 and 16, the center mounting element 65 includes two support braces 68 angled relative to each other, and attached at one end to the water tower 30, such as by welding, and at an opposing end to a one- or multi-piece support column 75 that extends to the ground or other surface, as shown in FIG. 14. FIG. 17 illustrates a concrete footing 77 partially buried in the ground adjacent a footing for the water tower 30, and for securing and supporting a bottom end of the support column 75. The support frames 50 can be attached to the support column 75 by any suitable connection, such as welding and/or bolts.

FIG. 18 illustrates the mounting elements 60 of FIGS. 14 and 15, according to one embodiment of this invention. The mounting elements 60 each include a clamp 70 formed by two clamp arms 73. Each clamp arm 73 is attached at one end to a lateral support 54 of the support frame 50, and at the opposing end to the vertical tower support 32 of the water tower 30. FIG. 19 illustrates a brace 85 for occasional bracing along the length of the support column 75 to the water tower 30.

Thus, the invention provides signage for a vertical structure like any of various types of water towers or similar architectural structures. The inventions allows for generating advertising revenue in a space generally devoid of other uses, but typically in view of commuters or other persons.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. Signage for attachment to an architectural structure having a vertical orientation, comprising a display attached to the architectural structure by a support frame and at an angle to the vertical orientation.

2. The signage of claim 1, wherein the support frame comprises a plurality of lateral supports extending between two vertical supports.

3. The signage of claim 1, wherein the display comprises an electronic display.

4. The signage of claim 3, wherein the display comprises a portrait display.

5. The signage of claim 1, wherein the support frame comprises a plurality of mounting elements attachable to the architectural structure, wherein mounting elements toward an upper end of the support frame have a first length and mounting elements toward a lower end of the support frame have a second length that is shorter than the first length.

6. The signage of claim 5, wherein the mounting elements comprise clamps.

7. The signage of claim 6, wherein the clamps are welded to the architectural structure.

8. The signage of claim 1, wherein the architectural structure is a water tower and further comprising reinforcement footings.

9. The signage of claim 1, further comprising a lower support beam connected to the support frame, and extending between the support frame and a support footing.

10. Signage for attachment to an architectural structure having a vertical orientation, comprising:
a support frame including an upper mounting element having a first length and a lower mounting element having a second length that is less than the first length; and
a display supported on the support frame, wherein the display is disposed at an angle to vertical upon attachment to the architectural structure as a function of the first length of the upper mounting element and the second length of the lower connection.

11. The signage of claim 10, wherein the support frame comprises a plurality of lateral supports extending between two vertical supports.

12. The signage of claim 10, wherein the display comprises an electronic portrait display.

13. The signage of claim 10, wherein at least one of the upper mounting element and the lower mounting element comprises a clamp.

14. The signage of claim 10, wherein the clamp comprises a friction pipe clamp.

15. The signage of claim 10, wherein at least one of the upper mounting element and the lower mounting element includes and end welded to the architectural structure.

16. Signage for attachment to an architectural structure having a vertical orientation, comprising:
a support frame including mounting elements attachable to vertical tower supports of the architectural structure, the mounting elements including an upper mounting element having a first length and a lower mounting element having a second length that is less than the first length; and
an electronic display supported on the support frame in a portrait configuration, wherein the electronic display is disposed at an angle to vertical upon attachment to the architectural structure as a function of the first length of the upper mounting element and the second length of the lower connection.

17. The signage of claim 16, further comprising a first upper mounting element and a first lower connecter each connected to a first vertical tower support of the architectural structure, and a second upper mounting element and a second lower connecter each connected to a second vertical tower support of the architectural structure.

18. The signage of claim 16, further comprising:
a second support frame connected to the support frame and supporting a second electronic display, each of the support frame and the second support frame attached to a corresponding vertical tower support of the architectural structure; and
a vertical support column connected between the support frame and the second support frame, and extending between the support frame and the second support frame and a support footing.

19. The signage of claim 16, wherein the architectural structure is a water tower and further comprising reinforcement footings adaptable to support the vertical tower supports.

20. The signage of claim 16, wherein at least one of the upper mounting element and the lower mounting element comprises an angled portion.
